(19) United States
(12) Patent Application Publication
(10) Pub. No.: US 2012/0119119 A1
(43) Pub. Date: May 17, 2012

(54) UV-CONVERTER, UV LAMP ARRANGEMENT WITH THE UV-CONVERTER, AND A LIGHTING UNIT COMPRISING THE UV LAMP ARRANGEMENT

(76) Inventor: Attila Soltész-Nagy, Miskocl (HU)

(21) Appl. No.: 13/386,103

(22) PCT Filed: Jul. 7, 2010
(86) PCT No.: PCT/HU2010/000079

§ 371 Date: Jan. 20, 2012

(30) Foreign Application Priority Data
Jul. 24, 2009 (HU) P0900463
May 28, 2010 (HU) P1000276

(51) Int. Cl. G21K 5/00; G02B 5/20

(52) U.S. Cl. 250/504 R; 359/361

(57) ABSTRACT

The invention relates to, UV-converter for transforming radiation of wavelengths above 200 nm to UVA and UVB radiation, having at least a light transmitting sheet (11, 12), with a luminescent coating (13) on one side of the sheet. According to the invention, the light transmitting sheet is of a material suitable for filtering out the UVC radiation, the luminescent coating on the surface of the light transmitting sheet is isolated from humidity, and the luminescent material comprises a phosphor for generating a UV spectrum specified for the solarium lamps. The invention further relates to UV-converter, UV lamp arrangement with the UV-converter, and a lighting unit comprising the UV lamp arrangement.

### TECHNICAL FIELD

The invention relates to a UV-converter, a UV lamp arrangement provided with the UV-converter, and to a lighting unit comprising the UV lamp arrangement. The UV-converter transforms a radiation of a wavelength above 200 nm to UVA and UVB radiation; it has at least one light transmitting sheet with, a luminescent coating formed on one side of the sheet. The UV lamp arrangement, especially the UV solarium lamp arrangement, has a UV light source arranged in a glass envelope, and at least one light transmitting sheet coated with a luminescent layer, positioned on at least one side of the light source.

### BACKGROUND ART

The electromagnetic radiation of higher frequency (of smaller wavelength) within the range of the invisible light is called ultraviolet (or UV) radiation. This spectrum range up to cca. 400 nm has been divided into three parts (UVA, UVB and UVC) based on their physiological effects. The spectral range of UVA extends from 400 nm to 315 nm, the spectral range of UVB extends from 315 nm to 280 nm, while the spectral range of UVC is below 280 nm. UVC radiation possess a germicide, cell destroying effect, therefore it is also called germicide radiation. The natural sunlight comprises all the three ranges, but the atmosphere absorbs UVC radiation entirely, while UVB and UVA radiations are predominantly absorbed. The tanning effect of the Sun has long ago been observed, and as it has been verified by subsequent research, the UVA and UVB ranges of the natural sunlight are responsible for this effect.

Lamps are also known for a long time, which generate radiation in the UVA and UVB ranges responsible for the tanning effect of the Sun. These lamps are distributed as suntanning lamps, and are primarily built into sunbeds (horizontal type solariums), or into sunbathing cabines (vertical type solariums), and are used therein. Such lamps are available from manufacturers, for example Lightech, Heraeus, Narva-light, Osram Sylvania, Jk-light, Cosmedico, etc. At present, there are various sunbed products available on the market, made by different manufacturers, such as Ergoline, Hapro, UWE, Soltron, Mega Sun, Black Care, etc.

Solarium lamps recently in use are UV lamps of low pressure, or of high pressure that can radiate in the UVA and UVB ranges. Nowadays UV lamps of low pressure are manufactured in various sizes ranging from 20 cm up to 200 cm and of different wattage. Their output is ranging from 10 W to 220 W. The glass material of the low pressure suntanning lamps or fluorescent lamps filters UVC rays fully out, and only UVA and UVB rays are transmitted. It is achieved by using the luminescent material comprising phosphor (later referred to as phosphor) applied onto the inner wall of the glass envelope of the lamp that the suntanning lamp will be suitable for solarcosmetic purposes by emitting light of appropriate spectrum in the UVA/UVB ranges. The useful lifetime of of the low pressure UV lamps is ranging from 400 to 1800 hours, the average being 800 hours. The high-pressure lamps may only be used together with a filter glass as their emitted light also contains small amounts of the UVC spectrum.

The lifetime of the UV lamps is affected by many factors, among which one of the most important factors is the degradation of the phosphor, which diminishes the light output of the lamp. The phosphor layer applied to the inner wall of the envelope is subject to heat treatment, and therefore, an efficiency loss of 10-15% is observed already in the manufacturing process. Moreover, during operation, UVC radiation of around 185 nm also hits the phosphor, which consequently degrades, and its efficiency will again decrease. The lifetime of the phosphor is also affected by the operating temperature. Owing to the high temperature in the medium or high pressure discharge lamps, phosphor cannot be used on the glass, therefore in these lamps a UV-filtering envelope or a separate UV filter is used.

The mercury vapour present inside the discharge lamps can also cause a significant decay of the phosphor. In view of the lifetime of the lamp and the environmental protection aspects, today mercury-free lamps are also produced, but the light output and the efficiency of these lamps are still lagging far behind to that of the mercury vapour discharge lamps.

There are UV lamp arrangements known for generating visible light or for general lighting purposes, wherein a phosphor coated glass sheet is placed outside the light source enclosed in a glass envelope by which ultimately the spectrum of the illuminating light is determined. Such UV lamp arrangements are described U.S. Pat. No. 2,413,940 and U.S. Pat. No. 5,736,744. In U.S. Pat. No. 2,413,940 a fluorescent light source is disclosed, having a UV light source surronded by a single or double layer glass envelope, with an inner and an outer phosphor layer applied to it. In case of a double layer glass envelope, the inner phosphor is applied to the inner glass envelope and the outer phosphor is applied to the outer glass envelope while in case of a monolayer glass envelope the inner phosphor is applied to the inner surface of the glass envelope whereas the outer phosphor is applied to the outer surface of the glass envelope. The outer phosphor transforms only the UV radiation of longer wavelengths to visible light while the inner phosphor only transforms the UV radiation of short, wavelengths to UV radiation of long wavelengths, thus increasing the efficiency of the light source. In addition, the space between the UV lamp and the outer envelope is a closed space which does not enable a sufficient cooling of the lamp. In the patent specification of U.S. Pat. No. 5,736,744 a wavelength shifting filter for a transilluminator is disclosed, that has two glass sheets separated by a spacer and held together with a frame, wherein a phosphor coating is applied between the two glass sheets. On one side of the filter a UV light source is arranged. The inner glass sheet facing the light source transmits UV light, while the other outer one only transmits visible light. To enhance the white light effect, the outer glass sheet may also be of white colour. These two lamps are used for generating visible light, and therefore they cannot be used as solarium lamps. Owing to the small output and short lifetime of the lamp, the problem of overheating when used as a solarium lamp had not to be dealt with.

In order to achieve the desired tanning effect in solarium equipments, for example in sunbeds and sunbathing cabines, a great number of small and medium output solarium lamps are used with a limited lifetime due to the above mentioned physical phenomena.

An objective of the invention is to provide a UV-converter for solarium lamps which maintains its effectiveness even in case of a high light luminous output and after a long time of operation. A further object of the invention is to provide a solarium lamp arrangement, comprising such a converter, having a long lifetime, which is not significantly influenced even by the operating temperature of the lamp arrangement. Yet another object of the invention is to provide a UV lighting unit comprising a solarium lamp arrangement that can favourably be applied in suitable solarium equipments.

The first objective of the invention is accomplished by a UV-converter for transforming a radiation of a wavelength above 200 nm to UVA and UVB radiation, which has at least one light transmitting sheet with a luminescent coating formed on one side of the sheet.

According to the invention the light transmitting sheet is of a material suitable for filtering out the UVC radiation entirely, the luminescent coating on the surface of the light transmitting sheet is isolated from humidity, and the: luminescent material comprises a phosphor for generating a UV spectrum prescribed for suntanning lamps.

The object of the invention with regard to the lamp is achieved by a UV lamp arrangement, especially by a UV solarium lamp arrangement, which has a UV light source, enclosed in an envelope, emitting radiation above 200 nm, and at least one light transmitting sheet coated with a luminescent layer. The light transmitting sheet is made of a material filtering off UVC radiation, the luminescent coating applied onto the surface of the light transmitting sheet is isolated from moisture, and the luminescent material comprises a phosphor for generating a UV spectrum prescribed for solarium lamps.

A further object of the invention is achieved by using a UV lighting unit comprising the solarium lamp arrangement provided with a UV-converter according to the invention.

By using the converter according to the invention it becomes possible to generate an artificial light required for suntanning, from a radiation having wavelengths above 200 nm, even in case of high luminous output, in a way that the phosphor does not get in contact with the mercury present in the light source, it is isolated from moisture and from the UVC radiation of wavelengths of about 185 nm, and from the heat generated in the light source of high output, all causing degradadation of the phosphor. In the lamp arrangement and lighting unit with the UV-converter according to the invention, also the conducting the heat away and/or the cooling of the UV-converter and of the UV light source, respectively, may be accomplished, if necessary. When using light sources of higher output together with an appropriate optical system, a smaller number of UV lamp arrangements, provided with a UV-converter according to the invention could be sufficient, and the lamp arrangements and the solarium equipments can be operated more cost-effectively, due to their longer lifetime. Moreover the invention makes it possible to modify the currently existing solarcosmetic devices in such a manner that the traditional sunbathing lamps are replaced by a combination of UV light sources and UV-converters according to the invention.

### SHORT DESCRIPTION OF THE DRAWINGS

Now the invention will be explained in more detail based on the preferred embodiments shown in the figures. The particular embodiments, the different variations are only shown to illustrate the invention, they are not intended to limit the scope of protection in any way.

FIG. 1 shows a schematic cross-sectional view of the UV-converter arrangement according to a first embodiment of the invention,

FIG. 2 shows a schematic cross-sectional view of the UV-converter arrangement according to a second embodiment of the invention,

FIG. 3 shows a schematic cross-sectional view of the UV-converter arrangement according to a third embodiment of the invention,

FIG. 4 shows a schematic cross-sectional view of the UV-converter arrangement according to a fourth embodiment of the invention,

FIG. 5 shows a schematic cross-sectional view of the UV lamp arrangement according to a first embodiment of the invention together with spacer and fixing elements,

FIG. 6 shows a schematic cross-sectional view of the UV lamp arrangement according to a second embodiment of the invention together with spacer and fixing elements,

FIGS. 7a-7d show schematic cross-sectional view of further embodiments of a UV lamp arrangement according to the invention, confined by a UV-converter,

FIGS. 8a-8d show schematic cross-sectional view of further embodiments of the UV lamp arrangement according to the invention, surrounded by a reflective surface and a UV-converter,

FIG. 9 shows a schematic cross-sectional view of a a first embodiment of a UV lighting unit comprising several light sources according to the invention,

FIG. 10 shows a schematic cross-sectional view of a second embodiment of a UV lighting unit comprising several light sources according to the invention,

FIG. 11 shows a schematic cross-section view of a third embodiment of a UV lighting unit comprising several light sources according to the invention,

FIG. 12 shows a schematic drawing of the cooling system of the UV lighting unit according to FIG. 11, in section,

FIG. 13 shows a schematic cross sectional view of the UV lighting unit provided with a UV lamp arrangement comprising a UV-converter according to the invention,

FIG. 14 shows a schematic drawing of the cooling system of the UV lighting unit according to FIG. 13, in partial section,

FIG. 15 shows a schematic drawing of a sunbed comprising the lighting units according to FIG. 13,

FIG. 16 shows a schematic drawing of a sunbed comprising the lighting units according to FIG. 13, and one additional unit,

FIG. 17 shows a schematic drawing of a solarium lamp arrangement, according to FIG. 10, wherein the lamp is provided with an elliptic light reflecting surface,

FIG. 18 shows a schematic drawing of a solarium lamp arrangement according to the invention, comprising a UV-converter and a UV light source, wherein the lamp is provided with an elliptic light reflecting surface,

FIG. 19 is a bottom view of an end closing and sealing element of a tubular UV-converter according to the invention, and

FIG. 20 is the tubular UV-converter according to the invention with the end closing and sealing element.

### DESCRIPTION OF THE EMBODIMENTS

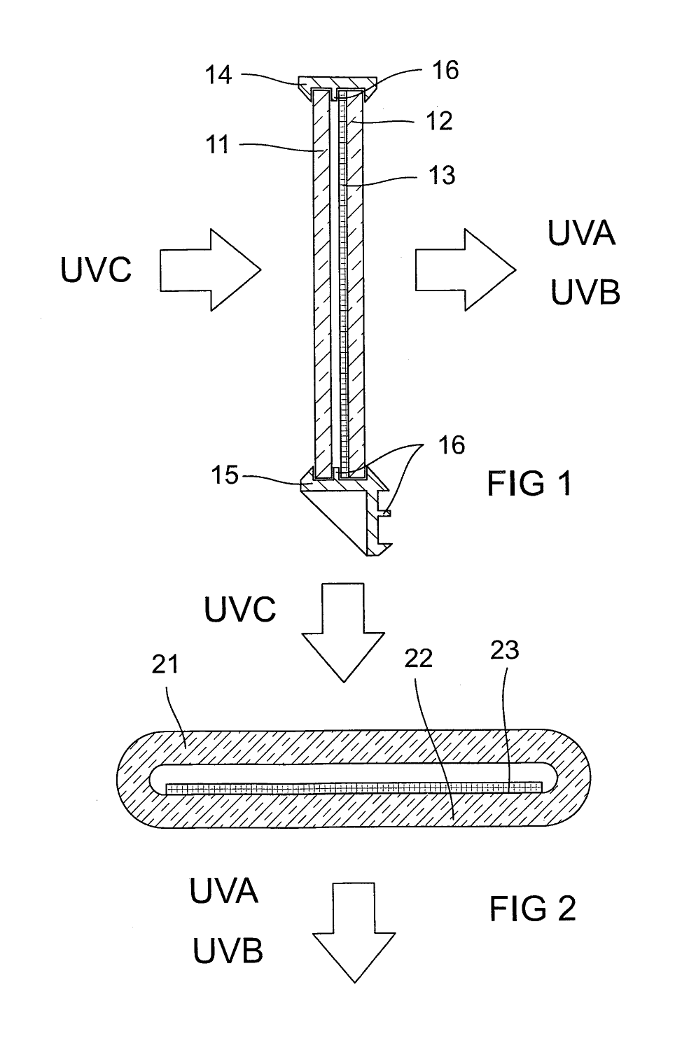

FIG. 1 shows a first embodiment of the UV-converter according to the invention for converting the radiation of wavelengths above 200 nm of a radiation source to UVA and UVB radiation. In the shown example the UV-converter has two light transmitting sheets 11 and 12 of essentially planar configuration, from which the light transmitting sheet 11 facing the light source transmits the light spectrum above 200 nm. The other light transmitting sheet 12 is made of a material filtering out the UVC radiation, and on its surface facing the UV light source a luminescent coating 13 is formed which produces a UV spectrum prescribed for solarium lamps. Another solution is also possible where the phosphor is applied to a side of the first light transmitting sheet 11, opposite to the light source. In both cases, the phosphor is placed in a space enclosed by the light transmitting sheets, which provides an adequate protection for the phosphor. The light transmitting sheets 11 and 12 are held together by a frame 14 and 15, and a spacer 16 is placed between the sheets in the edge region of the sheets. Between the edges of the light transmitting sheets and the frame insulating and sealing material can be applied which prevents moisture from the environment to get in contact with the luminescent layer 13. The insulating and packing material may be rubber, artificial rubber, silicon rubber, or the like. The material of light transmitting sheets 11 and 12 is glass, including for example silica glass, with additives that provide for the desired light transmittance spectrum. In addition, the material of the light transmitting sheet may also be a plastic, if the necessary heat resistance and light transmittance is ensured. The light transmitting sheet facing the light source 11 and providing mechanical and optical protection for the luminescent layer 13, may also be a thin foil or protective layer applied or fixed to the phosphor. In case of applying a thin foil or a protective layer there is no need for spacers.

The example according to FIG. 2 differs from the example of FIG. 1 only in the feature that the two light transmitting sheets 21 and 22 are bound to each other hermetically.

According to a further aspect for selecting the material of the two light transmitting sheets, the thermal expansion coefficients of the two light transmitting sheets should be identical, in order to avoid mechanical stresses or break. The air-tight connection may for example be achieved by gluing or welding. The interspace between the light transmitting sheets can be filled with a gas or a gas mixture, for example with nitrogen or argon, where the gas fill may optionally also contain metal halides. It is also possible to create vacuum in this spacing. To provide a distance or space between the light transmitting sheets bound together air-tightly, there is no need for spacers, and even the spacing is omissible, that is the two light transmitting sheets can be in contact with the luminescent layer.

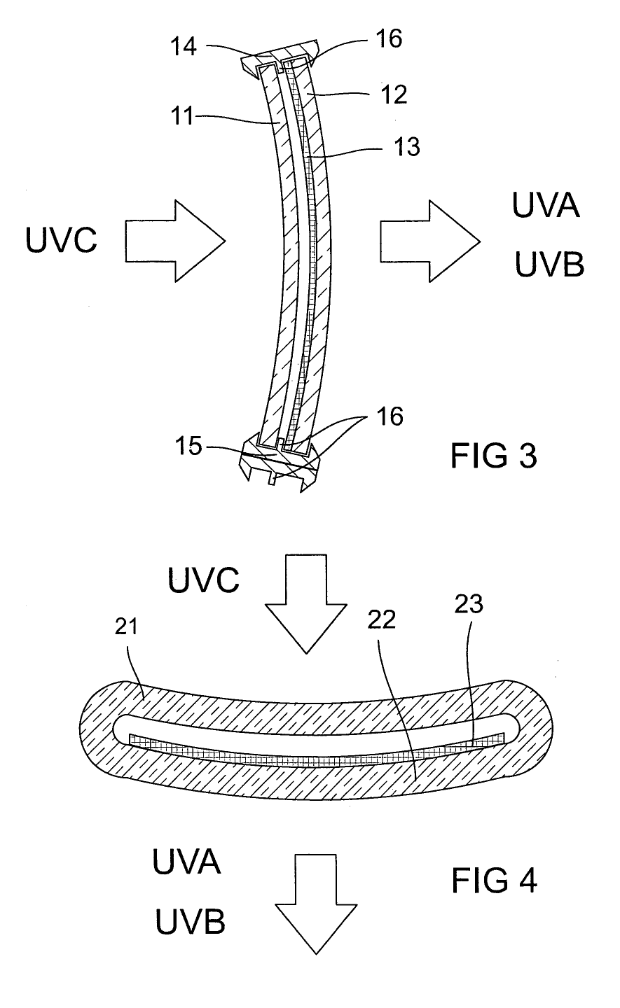

The UV-converter arrangement according to FIG. 3 is essentially identical with that of FIG. 1, whereas the UV-converter arrangement according to FIG. 4 is essentially identical with that of FIG. 2, with the difference that the light transmitting sheets 11, 12, 21, 22 have a curved shape. The frame 14, 15, holding the sheets together, shown in FIGS. 1 and 3, and the spacers 16 that separate the sheets from each other may also be made of one piece. The upper frame element 14 is shown in the drawing as an end closure element, while the lower element 15 is a frame element suitable for receiving and fixing an additional pair of light transmitting elements. In the embodiment shown in FIG. 1, the lower frame element 15 is formed for receiving and fixing a second pair of light transmitting elements (not shown) essentially perpendicular to the first one, shown in the drawing. Instead of the rigid pairs of frame elements, essentially perpendicular to each other, or having other angular position, the pairs of frame elements may be connected to each other by joints, whereby the pairs of light transmitting elements can be adjusted in any desired angular position. By using more light transmitting sheets 11, 12, 21, 22 of curved shape, according to FIG. 3 or 4, and by coupling them together, also a closed cylindrical surface may be formed.

Further the cylindrical surface may be shaped up so that the light transmitting sheets having a closed cylindrical surface, that may be configured to form a double walled tube. In this case only one circular end sealing element is needed at the ends of the cylindrical tube, which optionally may comprise the spacers, too. The material of the profiled frame element 14, 15 is advantageously metal or plastic with the required heat resistance properties. It is not shown in FIGS. 2 and 4, but the light transmitting sheets shown there may of course be linked together, too, by applying appropriately formed frame elements.

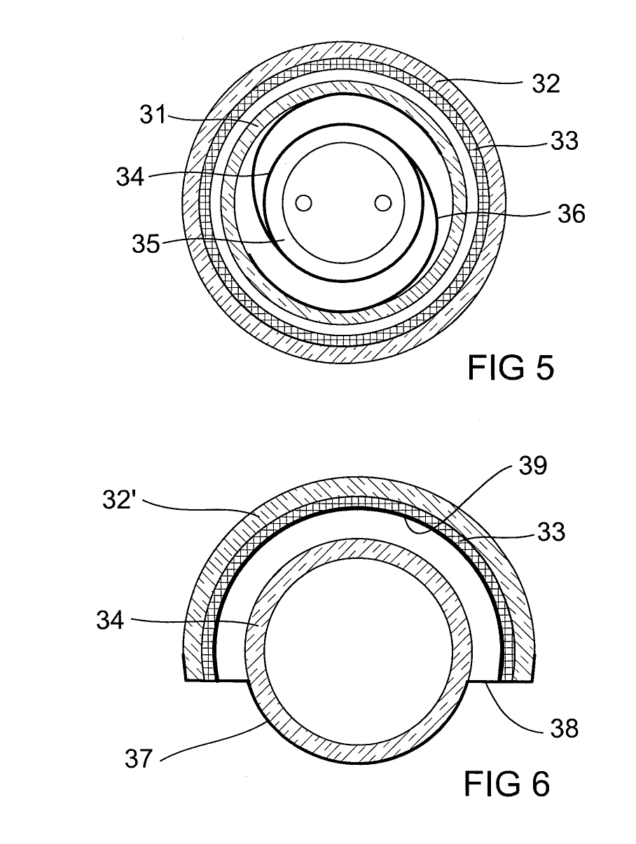

FIG. 5 shows a, UV lamp arrangement, especially a UV suntanning lamp arrangement with a UV light source arranged in an envelope 34 and two essentially cylindrical light transmitting sheets 31, 32, where the light transmitting sheet 31 facing the UV light source transmits the spectrum above 200 nm. The other light transmitting sheet 32 is made of a material filtering out UVC radiation, and on its inner side, that is facing the UV light source, a luminescent coating 33 is formed for producing the UV spectrum required for solarium lamps. The lumindescent coating may also be applied to the outer surface of the light transmitting sheet 31, when required. The cylindrical light transmitting sheets 31, 32 are held together by a frame (not shown), and there is a spacer between the sheets, positioned in the edge region of the sheets. Between the frame and the edges of the light transmitting sheets, insulating or sealing material can be applied, which prevents the moisture content from the environment to get in contacting with the luminescent layer. The insulating or sealing material can be rubber, artificial rubber, silicon rubber, or the like. Th material of the light transmitting sheets 31, 32 is glass, including for example silica glass, with additives that provide for the desired light transmittance spectrum. In addition, the material of the light transmitting sheet may also be a plastic, if the necessary heat resistance and light transmittance is ensured. One of the light transmitting sheets is thus forming a phosphor carrier sheet, while the other light transmitting sheet provides for a mechanical protection of the phosphor. The sheet opposed to the carrier sheet can optionally be replaced by a protective layer or foil. The optical properties of the carrier and protective layer or sheet, respectively, are identical with those described above, depending on their position. When applying a foil or a protective layer, there is no need for spacers. In the shown embodiment, the UV light source comprises at least one UV light source of high pressure, of medium pressure, or of low pressure. The UV light source is preferably radiating in a spectrum above 200 nm, and may optionally emit radiation even in the visible light spectrum, and is arranged in a closed envelope. The 200 nm cut is ensured by the envelope. In case of UV light sources of low pressure, for example germicide lamps, the emitted light spectrum is limited essentially to the wavelength of about 254 nm. UV light sources of medium pressure are emitting light at several characteristic lines within the UV spectrum. The cutting off of the radiation below 200 nm significantly decreases the degradation of the phosphor, and therefore increases its lifetime, moreover formation of ozone, harmful to health, will also be excluded in the open space outside the light source. The composition of the luminescent layer in the UV-converter surrounding the light source should be selected according to the type of the light source. Any kind of activator can be used, but it is preferred to select phosphors which are cerium- or europium-activated, for these are not toxic, as for example those which are lead-activated. Phosphors with cerium-based activators are more stable, although they are not so heat resistant at elevated temperatures.

The optimal operating temperature of the phosphors is in the range of 25-300° C., within which the most favourable range is between 25-100° C., since it is acceptable for every kind of phosphors. The luminescent layer; used in the UV-converter may, although not exclusively, consist of for example the following compounds: SrB₄O₇:Eu, YPO₄:Ce, (MgBa)Al₁₁O₁₉:Ce, LaPO₄:Ce, SrAl₁₂O₁₉:Ce, LaB₃O₆:Bi³⁺,Gd³⁺, LaMgAl₁₁O₁₉:Ce, BaMgAl₁₁O₁₉:Ce, (Y,Gd)PO₄:Ce, BaSi₂O₅:Pb, Sr₂MgSi₂O₇:Pb, BaSO₄:Eu. Currently the most efficient phosphors are the so-called BSP phosphors, such as the Nichia NP-800 BaSi₂O₅:Pb, or the NP-805 YPO₄:Ce. The length of the light sources is advantageously between of 180 cm and 200 cm. In case of shorter light sources a plurality of light sources are arranged preferably in a line.

Instead of using frames with sealed end closure elements and spacers, it is also possible to connect the inner and outer light transmitting sheets hermetically, which can be accomplished for example by gluing or welding.

In the figure a possible solution for holding and fixing the UV light source inside the cylindrical UV-converter can be seen. The fixing is accomplished by at least one flexible spacer element 36 which consist of flexible lamellas joined to a cylindrical part connected to the metal cap 35 of the UV lamp, according to an embodiment shown in the drawing. The UV lamp together with the flexible spacers mounted on it can be placed inside the cylindrical UV-converter so that, during inserting, the flexible spacer elements 36 will be held in a compressed state, and they will only in the final position of the lamp be allowed to expand freely and be pressed onto the cylindrical wall of the UV-converter.

The UV lamp arrangement provided with the UV-converter, shown in FIG. 6, differs from the example according to FIG. 5 in that the UV light source is surrounded by the UV-converter only partially. In this case, the glass envelope 34 of the inner UV light source is provided with a reflecting surface 37 at the bottom, which is connected to a cylindrical UV converter 32′ through a light-impermeable sheet 38. The cylindrical UV converter 32′ is open below, or it is closed at the bottom by light-impermeable sheets 38. The reflecting surface 37 and the two light-impermeable sheets are preferably made from one single metal sheet with a reflecting surface, advantageously from an aluminium sheet. On the two sides of the light-impermeable sheet a guiding means is formed which recieves the lower edge of the cylindrical UV-converter. In this case protection of the phosphor, applied on the inner surface of the light transmitting sheet 32′, against moisture is provided by a protective layer or foil 39 and thus in this embodiment the second light transmitting sheet may be omitted. The advantage of this UV lamp arrangement is the smaller amount og glass required in manufacturing which results also in a considerable reduction of weight. In-addition, the cooling of this UV lamp arrangement is more effective.

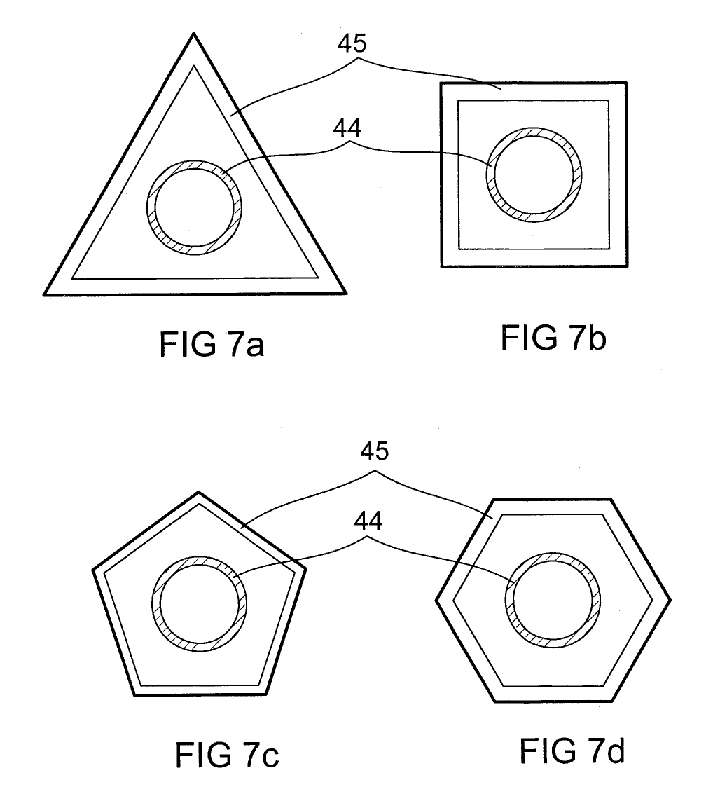

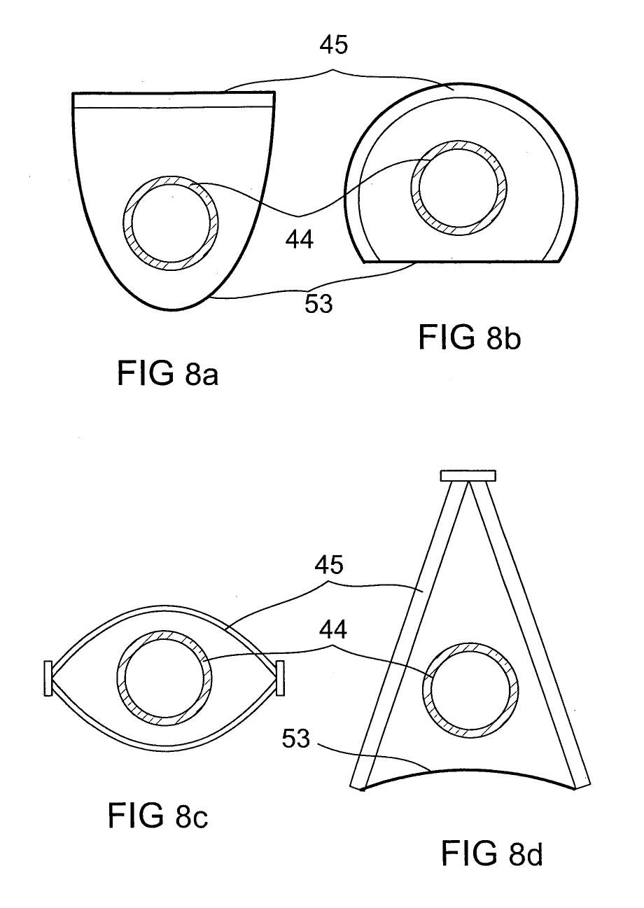

The light sources may be surrounded by one or more flat UV-converter. This can be seen in different embodiments in FIGS. 7a-7d. The light source 44 is surrounded in FIG. 7a by three, in FIG. 7b by four, in FIG. 7c by five, and in FIG. 7d by six flat UV-converters 45. In FIGS. 8a-8d the light sources are surrounded by at least one UV-converter and by a reflecting surface. The light source 44 is surrounded in FIG. 8a by one curved reflecting surface 53 and by one flat UV-converter 45, in FIG. 8b by one flat reflecting surface 53 and one curved UV-converter 45, in FIG. 8c by two curved UV-converters 45, while in FIG. 8d it is surrounded by one curved reflecting surface 53 and by two flat UV-converters 45. These UV-converters are preferably double-walled UV-converters 45 according to FIG. 1 or 2, or can be flat UV-converters provided with a protective layer, too. In these embodiments the UV-converters 45 may of course be for example double-walled UV-converters 45 according to FIG. 3 or 4, or also curved UV-converters provided with a protective layer. In accordance with the invention it is also possible to combine at least one flat and at least one curved UV-converter, as desired. At least one of the flat or curved UV-converters can be replaced by a light-impermeable or optionally by a surrounding sheet preferrably with reflecting surface. The distance of the UV-converter sheets from the light source is adjusted so, that the temperature of the light transmitting sheet carrying the phosphor will not reach the critical temperature of phosphor degradation, e.g. it will remain all time below 150° C., preferably below 120° C.

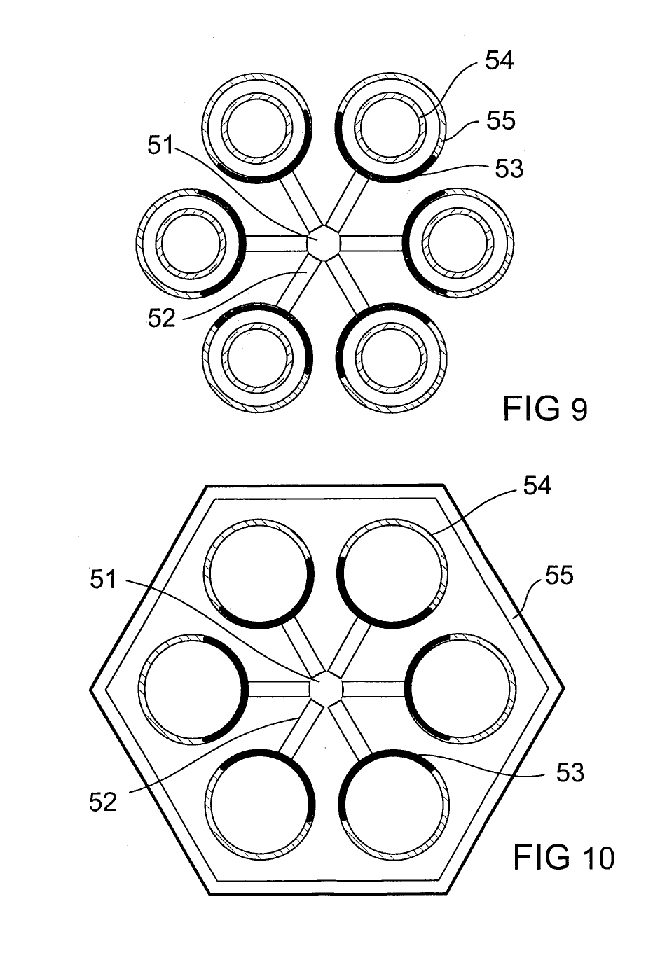

In FIGS. 9-11, lighting modules of essentially cylindrical shape can be seen, the entire length of which is approximately 2 m, their diameter may be vary between about 3 and 30 cm, depending on the light output. Some cylindrical modules may be even shorter. In this case the total length of modules is composed of the lengths of the several assembled module parts.

In FIGS. 9 and 10 a lighting module containing six UV lamps- or UV lamp arrangements can be seen, where the UV lamps are arranged along a circle or, in the vertices of a regular hexagon, respectively, essentially parallel to each other. The number of lamps used in the arrangement may of course be less (two, three, four or five) or even more (seven or eight, for example), where the lamps are also arranged preferably in a regular pattern. The arrangement has a central supporting rod 51 to which radially protruding connecting elements 52 are joining, each of them holding one lamp 54. In the embodiment of FIG. 9, the UV lamps 54 are surrounded by a double-walled, cylindrical UV-converter 55 of FIG. 5, while in the embodiment of. FIG. 10, there are UV lamps 54 without UV-converters, for example germicide lamps, arranged on the connecting elements 52. In this arrangement, similarly to FIG. 7d, the UV-converter 55 is formed by six flat UV-converters connected to one another, each of them being a flat UV-converter according to FIG. 1 or 2. Instead of the flat UV-converters a cylindrical UV-converter may also be used. In order to enhance the lumen output, the wall of the outer light transmitting tube in the embodiment of FIG. 9 is covered in part by a reflecting surface 53 which directs the light produced by the lamp in the desired direction. In another possible example the reflecting surface is provided on the wall of the UV light source. The reflecting surface is preferably placed on the side facing the central supporting rod 51 where the shading effect of the connecting elements would anyway decrease the lumen output. In the embodiment of FIG. 10 the cylindrical envelope of the UV lamp is partly covered by a reflecting surface 53 in order to achieve the same effect. The reflecting surface may be formed either on the inner or on the outer surface of the tubes. The material of the reflecting surface formed on the inner surface may for example, but not exclusively be MgO, BaSO₄, Al₂O₃. The outer reflecting surface can be formed by evaporated aluminium deposited on the surface, or from a reflecting metal sheet of cylindrical shape.

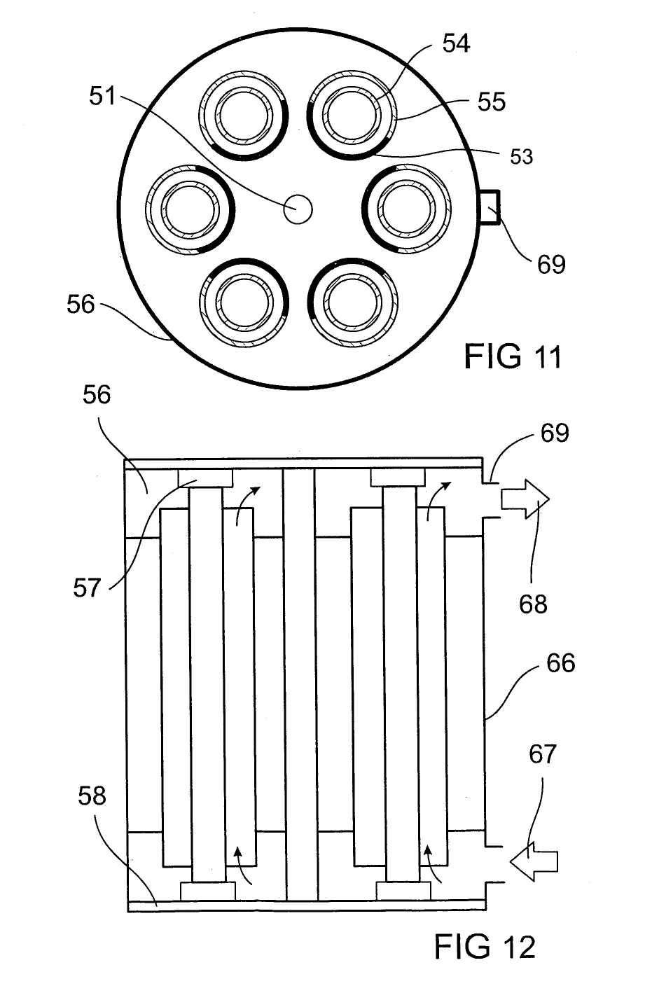

In FIGS. 11 and 12 a lighting module can be seen again containing six UV lamp arrangements, where the UV lamp arrangements are arranged along a circle or in the vertices of a regular hexagon, respectively. The number of lamps used in the arrangement may of course be less (two, three, four or five) or even more (seven or eight, for example), where the lamps are also arranged preferably in a regular pattern. The arrangement has a central supporting rod 51 at the longitudinal ends of which each an air deflector unit 56 and an electric connecting unit 58 are provided. The air deflector unit 56 is provided with an air intake and outlet 69. The ends of the UV lamps 54 surrounded by the cylindrical UV-converter 55 protrude into the air deflector unit 56. The UV lamps 54 are supplied with operating voltage through a socket 57 being connected with the electrical connecting unit 58. The air deflector units 56 and the UV lamp arrangements are preferably surrounded by a cylindrical light transmitting cover, e.g. by a plastic cover.

In order to enhance lumen output, the wall of the outer cylindrical light transmitting tube is in part covered by a reflecting surface 53 which directs the light produced by the lamp in the desired direction. In another possible example the reflecting surface is provided on the wall of the UV light source. The reflecting surface is favourably positioned on the side facing the central supporting rod 51 where the shading effect of the connecting elements would anyway decrease the lumen output. The reflecting surface may be formed either on the inner or the outer wall surface of the tubes. The arrow 67 in the drawing indicates the flow of the coolant into the lower air deflector unit 56. From here the coolant medium flows upwards inside the UV-converters, towards the upper air deflector unit 56, while taking up heat. The warmed up coolant leaving the upper flow channel is indicated by arrow 68 in the drawing. In order to attain the desired cooling effect, it is therefore possible to direct a coolant of controlled volume and temperature into the space around the high output and hence strongly heat developing UV lamps. By cooling the UV light sources, the temperature of the phosphor inside the UV-converter remains always on a low level (below 120° C.), and therefore its decay will not come about, or the degradation will only occur well belated, as compared to lamps without appropriate cooling. The cooling provides also for operating temperature of 4-45° C. for the low pressure germicide lamps.

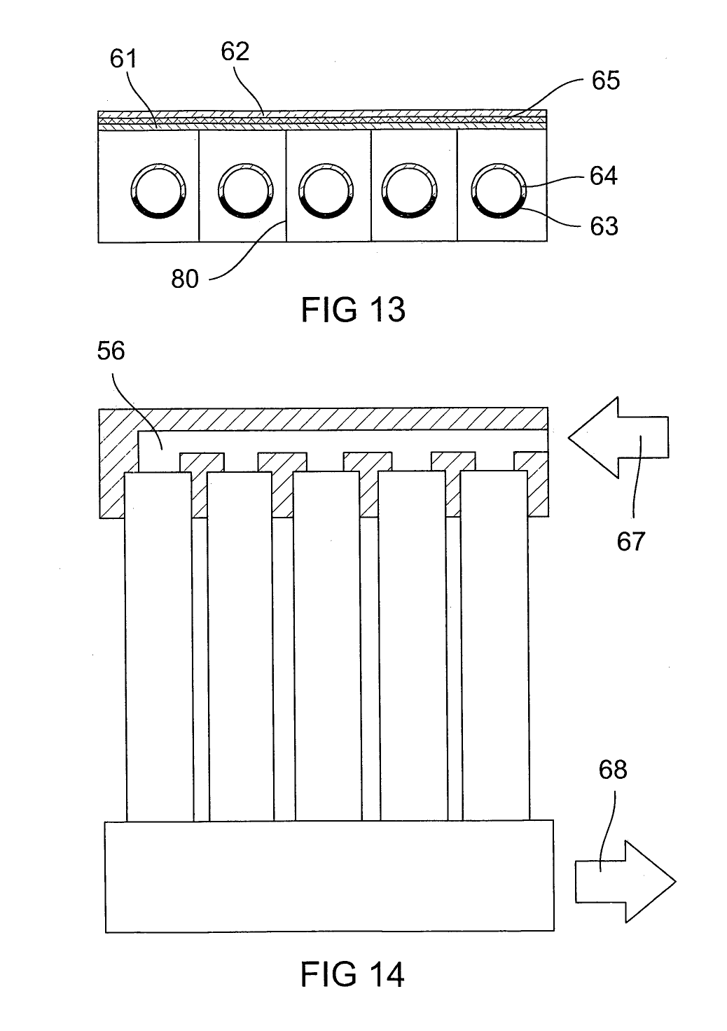

In FIG. 13 a lighting unit or module containing a plurality of UV lamp arrangements can be seen. Here five pieces of UV lamps 64, for example germicide lamps, without UV-converters are placed in a rectangular box, parallelly to each other, side-by-side, and in a row, where only the upper side of the box is covered by a flat UV-converter, comprising light transmitting sheets 61, 62 with a phosphor layer 65 between the sheets, wherein the length of lamps is essentially identical with that of the box. The number of the UV lamps can of course be choosen differently, too. The UV light source in the lighting unit may optionally also be a compact UV fluorescent tube (germicide lamp). In case of compact UV fluorescent tubes, the length of the tube is essentially a half of the length of the box, and the light tubes are attached on the two longitudinal ends of the box, pointing at an opposte direction. In order to achieve, better lumen output, a part of the UV lamp 64 is covered by a reflecting surface 63 which directs the light produced by the lamp in the desired direction. The reflecting surface 63 is provided preferrably on the bottom side where the shading effect of the box would anyway decrease the lumen output. It can be considered as an essentially equivalent solution if there are UV lamps provided with UV-converters in the box, and the upper side of the box is transparent to the UV light and does not contain UV-converter. In this case any of the UV lamp arrangements of FIGS. 5-8 is applicable in the UV lamp arrangements. To attain a better lumen output, a reflecting surface may be applied in the way described above. In the embodiment shown there are separating and supporting sheets 80, placed between the UV lamps 64, which can function as air deflectors, light transmitters, or UV mirrors, as well.

In each of the FIGS. 5 to 8 UV lamp arrangements can be seen wherein the the space between the inner UV lamp and the surrounding UV-converter or reflecting surface is open on both ends, and the cooling of the light sources is ensured by natural or forced air circulation. In order to provide protection for the UV lamps used as light sources and/or to UV-converters containing phosphor, it is advisable to use forced circulation in each case when cooling. In FIGS. 12 and 14 a circulation unit is shown with forced circulation for cooling the lamps. In this embodiment the UV lamps, provided with UV-converters, are connected to each other on both ends by an air deflector unit 56. The flow channels provide for free flow of the coolant between the inner UV lamp and the outer UV-converter. In the drawing, arrow 67 indicates the flow of the coolant into the upper flow channel. From here the coolant flows downwards through the individual UV-converters, towards the lower flow channel, while taking up heat. The warmed up coolant leaving the lower flow channel is indicated by arrow 68 in the drawing. In order to attain the desired cooling effect it is therefore possible to direct a coolant of controlled volume and temperature into the space around the high output and hence highly heat dveloping UV lamps. Due to the cooling, the temperature of the phosphor inside the UV-converter remains always on a low level (below 120° C.), and thus its decay will not take place, or the degradation will only occur much later, as compared to lamps without adequate cooling. The cooling provides also for the operating temperature of 4-45° C. for the low pressure germicide lamps.

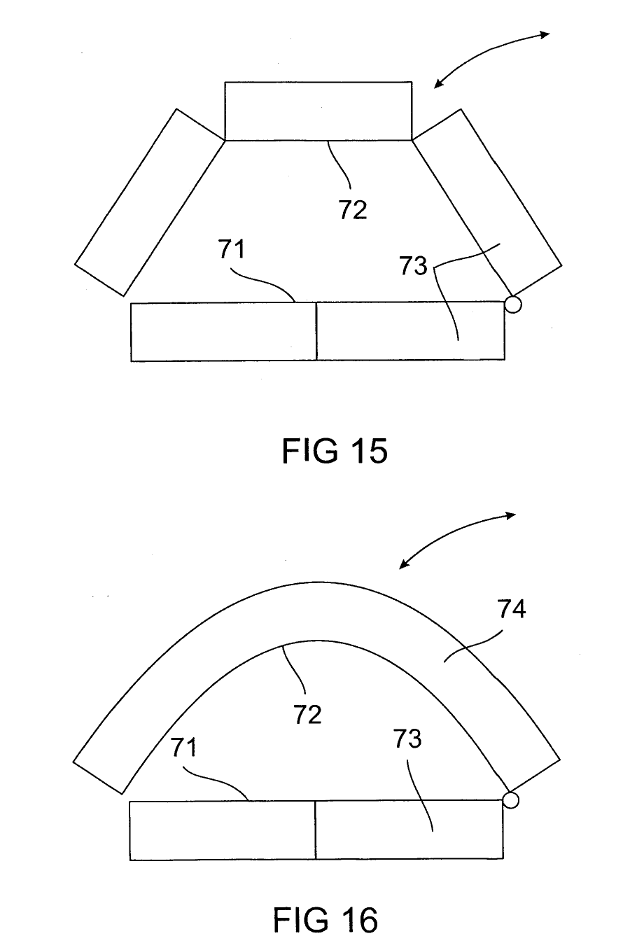

FIG. 15 shows a sunbed with lighting units or modules, for example according to FIG. 13. The body supporting surface 71 of the sunbed is composed of two, while the cover part 72 that can be opened is composed of three lighting units or modules 73, respectively. The size of a module is e.g. 40×200 cm. In FIG. 16 shows an upper cover part 72 that can be opened, made from one single curved lighting unit 74 having the same configuration as already discussed above with reference to FIG. 13. The lighting units contain thus several UV lamps, provided with UV-converters, or without UV-converters, whereas in the latter case it is necessary to apply one or more common flat or curved UV-converters, in place of the UV-converters surrounding the individual lamps. Similar to the examples of FIG. 15 or 16, suntanning cabines can also be prepared from lighting units, where in lieu of the body supporting part another part having a shape similar to the upper part may be applied. Considering the individual demands, in the particular arrangements any desired number of modules can be choosen.

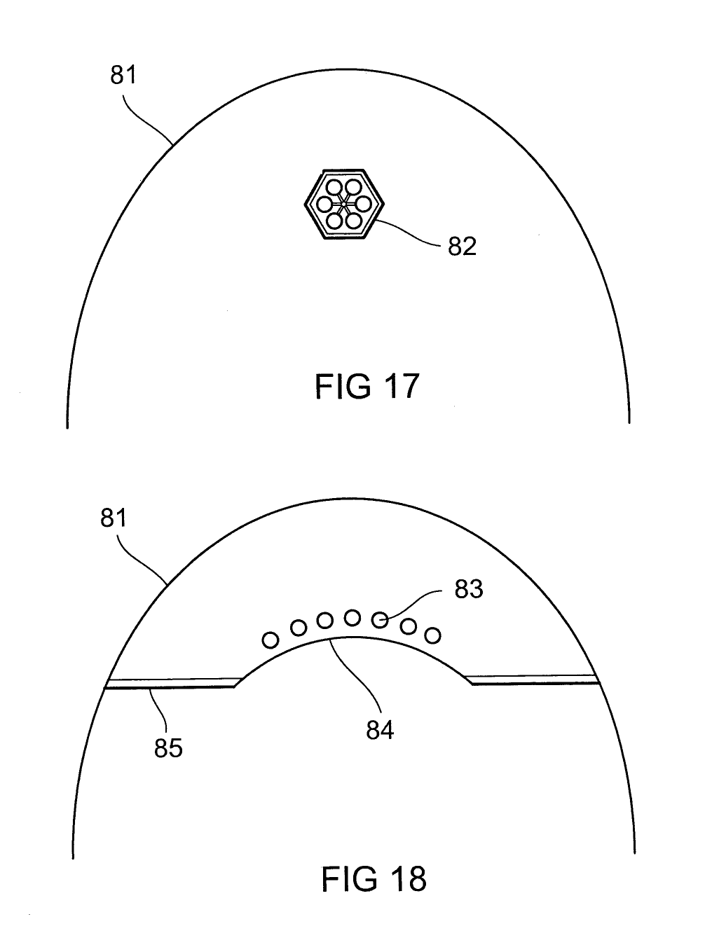

In FIGS. 17 and 18 combinations are shown where the UV lamp 83, and UV lamp arrangement 82, according to the invention, are used in combination with an elliptic reflecting surface 81 proposed in an earlier patent application no HU P0800505 of the Applicant. As shown in FIG. 17, the UV lamp arrangement according to FIG. 10 is placed essentially into the focal point of the elliptic reflecting surface 81. In this case the central supporting rod holds the UV lamps, the UV-converter of hexagonal cross-section, and optionally, also the circulation unit necessary for cooling. In another possible configuration the lamp arrangement of FIG. 9 is placed essentially into the focal point of the elliptic reflecting surface 81. In this case it would be expedient to surround the lamp arrangements with a common, e.g. cylindrical protecting tube, the material of which is plastic, e.g. fiberglass (see FIG. 12). In the embodiment of FIG. 18 the UV lamps 83 are UV lamps without UV-converter, that are fixed to a curved reflecting surface 84, in the vicinity of the focal point of the elliptic reflecting surface 81. The curved reflecting surface 84 directs the light towards an elliptic reflecting surface 81. In the free space between the curved reflecting surface 84 and the elliptic reflecting surface 81 a flat UV-converter 85, according to the invention (see FIG. 1 or FIG. 2), is placed which converts the radiation of above 200 nm, emitted by the lamps, to radiation falling into the UVA and UVB range, that is specified for solarium lamps.

Of course it is also possible to use an arrangement wherein the UV lamps provided with UV-converters (see FIGS. 5-8) are fixed to the curved reflecting surface. In this case there is no need to apply an additional UV-converter in the free space between the curved reflecting surface, and the elliptic reflecting surface.

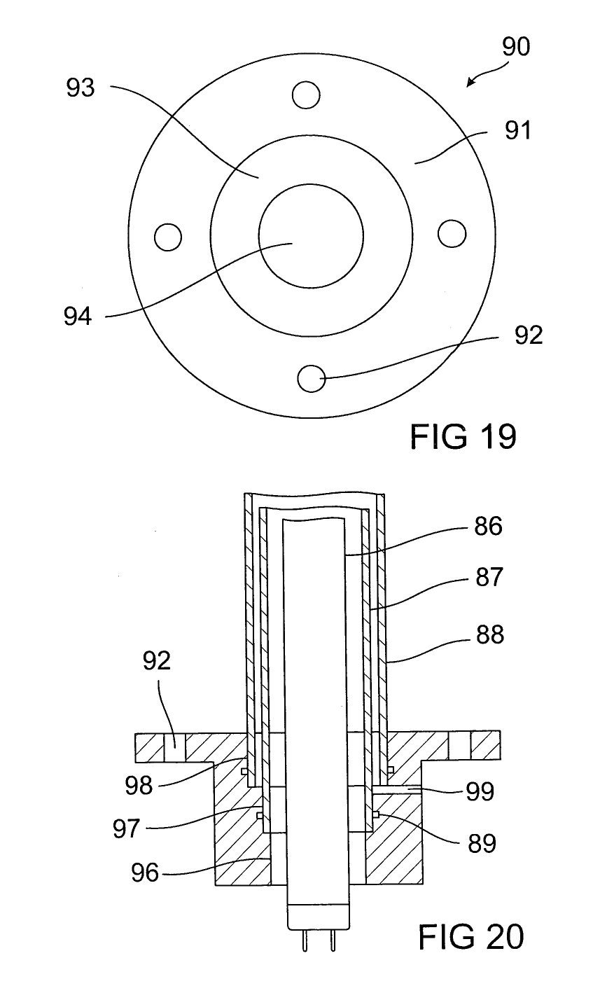

Finally FIGS. 19 and 20 show a specific embodiment of a cylindrical UV lamp arrangement, especially UV suntannig lamp provided with a UV-converter according to the invention. According to this embodiment, similarly to the example of FIG. 5, the light source 86 also radiating in the UVC spectrum is surrounded by a UV-converter according to the invention, wherein the UV-converter has an cylindrical inner light transmitting tube 87 and an outer light transmitting tube 88. The inner light transmitting tube 87 has a material, e.g. a silica glass, which transmits at least a part of the UVC spectrum. The outer light transmitting tube 88 may be made of a material completely suppressing any radiation of the UVC range, and on its inner side, that is facing the UV light source, a luminescent coating 33 is formed for producing the UV spectrum required for solarium lamps. This outer light transmitting tube 88 may be preferably a conventional suntan lamp tube, preferably a tube with a reflective surface, which is open on both ends. As shown in the drawing, the light transmitting tubes 87 and 88 are fixed and held together with an end closure and sealing element 90 on each ends of the tubes, the end closure and sealing elements having a flanged portion 91 and a cylindrical portion 93 with a central opening 94. For fixing purposes within the solarium apparatus, the flanged portion 91 is provided with holes 92. For receivint and fixing of the light source 86 and the light transmitting tubes 87, 88, the central opeing 94 of the cylindrical portion 93 has a stepped configuration. The central opening 94 is configured so, that in a portion 96 with the smallest diameter the light source can be received conveniently and enough free space remains for the circulation of the coolant. The light source 86 is for example a T6 light tube with an outer diameter of 19 mm. The inner diameter of the smallest portion 96 is substantially equal to the inner diameter of the inner light transmitting tube 87, which is 30 mm, in this embodiment. The outer diameter of the inner light transmitting tube 87 is for example 33 mm; which is equal to the inner diameter of the middle portion 97 having a medium sized diameter. The inner diameter of the largest portion 98 of the central opening 94 is equal to the outer diameter of the outer light transmitting tube 88, which is 38 mm in this example. The equal size of the outer diameters of said tubes and the inner diameters of the central opening means that they provide for a clearance fit when taking into account also the thermal expansion of the different materials, that is no thermal stresses in the glass material can develop which could lead to break. Between the end closure element 90 and the light transmitting tubes 87, 88 sealing elements of thermal resistent material can be applied. Such a sealing element may be a sealing ring or a silicon mass that can be inserted into grooves 89 shown in the drawing. In the embodiment shown in the drawing the end of the light source 86 extends slightly beyond the closing element. A light source of a length of about 2 m, both ends may be provided with a socket. Shorter light sources, for example of a length of 2×1 m, only one end of the light sources is provided with a socket. The end provided with a socket may be, in the example shown in the drawing, the outer end of the light sources. The light sources are positioned in the UV-converter preferrably coaxial in order to achieve a uniform light distribution, but in specific cases it might also be advantageous to have an excentric configuration, when the light sources provide greater luminous intensity in one direction. It may be advantageous to fill the space between the inner light transmitting tube 87 and the outer light transmitting tube 88 with a protective gas such as nitrogen or argon of low moisture content. For this purpose the cylindrical portion of the closure element may be provided with a filling and evacuating opening 99, that can be closed. In the most simple case, the space between the two light transmitting tubes can be closed with a closing and sealing ring, which may be provided with a filling and evacuating opening, that can be closed. Its material may also be a thermally resistant plastic, such as PTFE (teflon).

The ozon free operation of the UV lamp, preferably UV solarium lamp with a UV-converter according to the invention may be accomplished basically in two different ways. In the first case the light source itself is ozon-free, that is a low pressure germicide lamp, more specifically a so called ozon-free amalgam lamp, which only radiates in the spectrum above 185 nm and most of its output is emitted in the spectrum above 200 nm. In this case the light source itself guarantees the ozon-fee operaton, thus also the inner light transmitting tube 87 may be made of a silica glass transitting in the total UVC spectrum. The cooling of the lamp may be accomplished in open system, as well. In the second case the light source in not ozon-free, therefore the light source is radiating in the total UVC spectrum. In this case the material of the inner light transmitting tube 87 has to be selected so, that it transmits only radiaton in the spectrum above 185 nm, in order of the protection of the luminescent layer provided on the outer light transmitting tube 88. In this configuration ozon may be produced in the space between the light source 86 and the UV-converter. In order to prevent this, a closed cooling system must be used, where the coolant may not comprise oxygen.

When applying UV lamps provided with UV-converters according to the invention, only the UV-converter contains phosphor, the lamp used as a UV light source does not. Owing to this factor the lifetime of the UV light source will be multiplied. In case of germicide lamps the lifetime of the light sources is in the range of 16000 to 35000 hours, while even of medium pressure discharge lamps it is at least 5000 hours. Since the phosphor used in the UV-converter is isolated from moisture, from the mercury vapor present in the lamp, it is protected against the radiation of wavelength of about 185 nm, and against the high operating temperature, its rate of degradation is diminishing considerably, and therefore, the lifetime of the UV-converter containing the phosphor will also be multiplied as compared to the traditional UV suntanning lamps.

The invention is primarily disclosed in the specification, in details, based on the embodiments shown in the drawings, however, as will be apparent to those skilled in the art, several modifications are possible in the embodiments described herein, without departing from the scope of protection of the invention as stipulated by the claims. The UV lamp arrangements and the lighting units may for example be operated, independent from the position shown in the drawing, in any (vertical, horizontal, or else) other position, too. The number and the shape of the UV-converters surrounding the UV light sources, and particularly that of the reflecting or light-impermeable sheets is also optional, or these can be freely combined with each other. It is also self-evident that any kind of UV lamps and UV-converters, or UV lamp arrangements or the suitable combinations thereof are applicable in the lighting units.

1. UV-converter for transforming radiation of wavelengths above 200 nm to UVA and UVB radiation, having at least a light transmitting sheet, with a luminescent coating on one side of the sheet, characterized in that the light transmitting sheet (12, 22, 32) is made of a material filtering out UVC radiation, the luminescent coating (13, 23, 33) provided on the surface of the light transmitting sheet is isolated from moisture of the environment and the luminescent material is selected from those producing a UV spectrum specified for solarium lamps.

2. The UV-converter of claim 1, characterized in that an ozon free light source is used for generating the radiation of wavelength above 200 nm and a second light transmitting sheet (32, 11, 21) is provided on one side of the light transmitting sheet (12, 22, 32) coated with the luminescent layer, wherein the second light transmitting sheet is made of a material transmitting the total UV spectrum.

3. The UV-converter of claim 1, characterized in that a light source radiating in the total UVC spectrum is used for generating the radiation of wavelength above 200 nm and a second light transmitting sheet (11, 21, 31) is provided on one side of the light transmitting sheet (12, 22, 32) coated with the luminescent layer, wherein the second light transmitting sheet is made of a material transmitting UV light in the spectrum above 200 nm.

4. The UV-converter of claim 2, characterized in that the light transmitting sheets (11, 12, 21, 22, 31, 32) are essentially planar sheets.

5. The UV-converter of claim 2, characterized in that the light transmitting sheets (11, 12, 21, 22, 31, 32) are sheets having a curved surface.

6. The UV-converter of claim 2, characterized in that the light transmittting sheets (31, 32) are sheets having a curved surface which is closed.

7. The UV-converter of claim 2 characterized in that the light transmitting sheets are held together by a frame (14, 15), and a spacer (16) applied between the sheets, in the edge region of the sheets.

8. The UV-converter of claim 7, characterized in that the frame (14, 15) and the spacer (16) are integrated into one piece.

9. The UV-converter of claim 7, characterized in that an isolating and sealing material is inserted between the frame (14, 15), and the light transmitting sheets (11, 12, 21, 22, 31, 32).

10. The UV-converter of claim 2 characterized in that the light transmitting sheets (21, 22, 31, 32) are connected to each other hermetically.

11. UV lamp arrangement, especially UV solarium lamp-arrangement comprising: a UV light source radiating light above the 200 nm spectral range, enclosed in an envelope (34); and at least one light transmitting sheet (32) coated with a luminescent layer, characterized by that the light transmitting sheet (32) is made of a material filtering out UVC radiation, the luminescent layer (33) provided on the surface of the light transmitting sheet is isolated from moisture of the environment, and the luminescent material is selected from those producing a UV spectrum specified for solarium lamps.

12. The UV lamp arrangement of claim 11 characterized in that the UV light source comprises at least one UV light source (44) of medium pressure.

13. The UV lamp arrangement of claim 11 characterized in that the UV light source comprises at least one UV light source (44) of low pressure.

14. The UV lamp arrangement of claim 11 characterized in that the UV light sources are arranged along at least one line, side-by-side, essentially parallel with each other.

15. The UV lamp arrangement of claim 14 characterized in that the UV light sources are arranged along at least one curved line.

16. The UV lamp arrangement of claim 11 characterized in that the light sources are covered by at least one flat converter (45) on their light emitting side.

17. The UV lamp arrangement of claim 11 characterized in that the light sources are covered by at least one converter (45) having a curved surface on their light emitting side.

18. The UV lamp arrangement of claim 11 characterized in that the light sources are covered by the combination of at least one planar and at least one curved shape converter (45).

19. The UV lamp arrangement of claim 11 characterized in that the light sources are covered by the combination of at least one planar, and/or at least one curved shape converter (45) and of a reflective surface (53).

20. The UV lamp arrangement of claim 11 characterized in that an open space between the light sources and the UV-converters is provided, and cooling of the light sources is accomplished by natural or forced circulation of the coolant.

21. The UV lamp arrangement of claim 20 characterized in that it comprises a circulation unit.

22. UV lighting unit comprising at least one UV lamp arrangement according to claim 11, provided with at least one UV-converter according to claim 1.
